(19) United States
(12) Patent Application Publication
(10) Pub. No.: US 2017/0132487 A1
(43) Pub. Date: May 11, 2017

(54) MOBILE IMAGE ANALYSIS UNIT

(71) Applicant: Heath AHRENS, Boonton, NJ (US)

(72) Inventor: Heath AHRENS, Boonton, NJ (US)

(21) Appl. No.: 15/342,277

(22) Filed: Nov. 3, 2016

Related U.S. Application Data
(60) Provisional application No. 62/251,764, filed on Nov. 6, 2015.

(51) Int. Cl. G06K 9/46

(52) U.S. Cl. CPC G06K 9/4671

(57) ABSTRACT

A method of generating a user profile including the steps of gathering images associated with the user, identifying potential objects in the images, gathering information on the user and the images and objects in the images, applying a statistical model to identify the objects based on the images and information, generating a profile of the user based on the identified objects and information

### RELATED APPLICATIONS

This application claims priority to U.S. Provisional Application No. 62/251,764, titled “Mobile Image Analysis Unit,” filed on Nov. 6, 2015.

### BACKGROUND OF THE INVENTION

As social media becomes more and more embedded into modern culture, information contained in media associated with social media postings has become unmanageable. Users of social media post images, text, articles, products and many other pieces of information related to their interests. Images posed by users also indicate locations where the user has been or passed through. While this information is valuable, there is currently no way to gather information on the images posted on social media.

Therefore, a need exists for a method of gathering information contained in images posted on social media.

### SUMMARY OF THE INVENTION

One embodiment of the present disclosure includes a method of generating a user profile including the steps of gathering images associated with the user, identifying potential objects in the images, gathering information on the user and the images and objects in the images, applying a statistical model to identify the objects based on the images and information, generating a profile of the user based on the identified objects and information.

In another embodiment, the images are gathered from more than one location.

Another embodiment includes the step of identifying if the potential object is in the foreground or background of the image.

Another embodiment includes the step of identifying text in the image.

Another embodiment includes the step of identifying a type of space the potential object is located.

Another embodiment includes the step of identifying at least one person in the image.

Another embodiment includes the step of associating each identified object with a predetermined category.

Another embodiment includes the step of gathering information on the at least one person identified in the image.

In another embodiment potential objects are identified using a statistical analysis.

Another embodiment includes the step of identifying a relative position of each potential object.

### BRIEF DESCRIPTION OF THE DRAWINGS

Details of the present invention, including non-limiting benefits and advantages, will become more readily apparent to those of ordinary skill in the relevant art after reviewing the following detailed description and accompanying drawings, wherein:

FIG. 1 depicts a block diagram of an Image Analysis System suitable for use with the methods and systems consistent with the present invention;

FIG. 2 shows a more detailed depiction of a computer of FIG. 1;

FIG. 3 shows a more detailed depiction of additional computers of FIG. 1;

FIG. 4 depicts an illustrative example of the operation of the Image Analysis System of FIG. 1; and

### DETAILED DESCRIPTION OF THE INVENTION

While various embodiments of the present invention are described herein, it will be apparent to those of skill in the art that many more embodiments and implementations are possible that are within the scope of this invention. Accordingly, the present invention is not to be restricted except in light of the attached claims and their equivalents.

Described herein is a system for developing a profile of a user based on images identified in images as well as other data gathered from a user's mobile device or social media posts. While there are systems directed to the identification of specific objects in an image, the correlation between the objects in an image and characteristics of the user is unique.

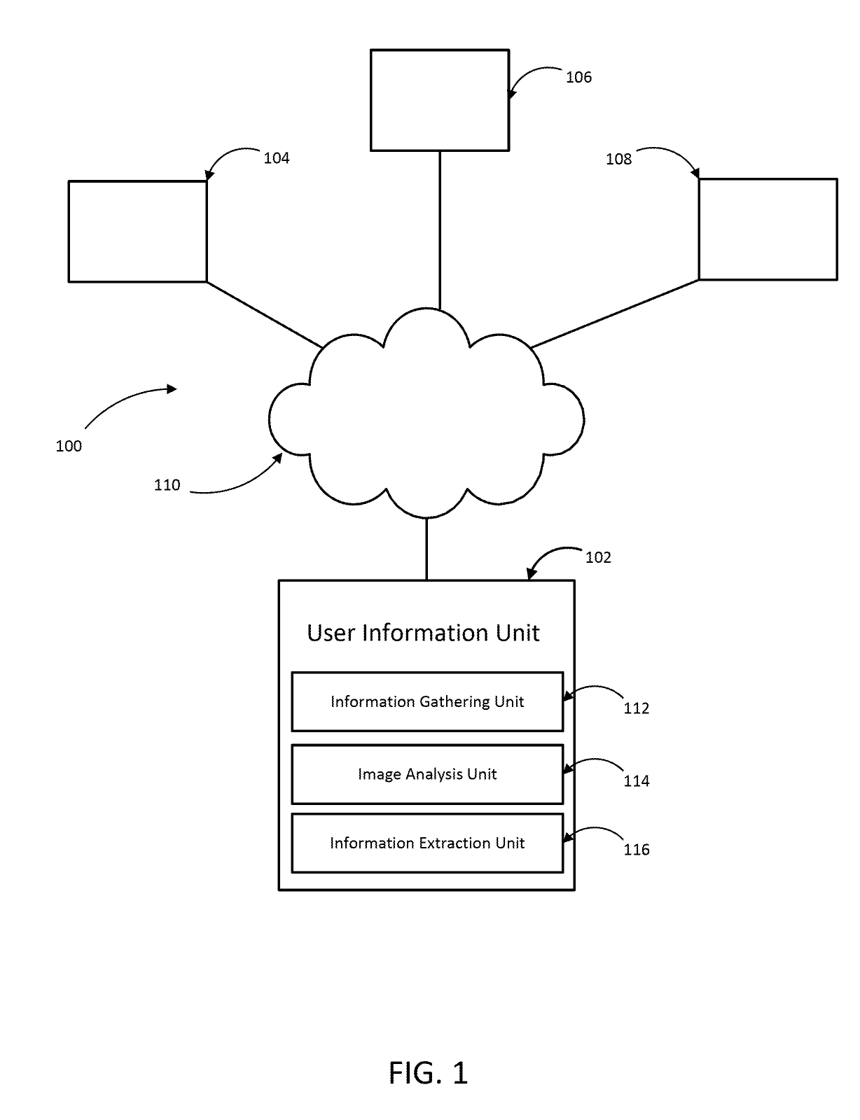

FIG. 1 depicts a block diagram of an Image Analysis System (“IAS”) 100 suitable for use with the methods and systems consistent with the present invention. The IAS 100 comprises a plurality of computers 102, 104, 106 and 108 connected via a network 110. The network 110 is of a type that is suitable for connecting the computers for communication, such as a circuit-switched network or a packet switched network. Also, the network 110 may include a number of different networks, such as a local area network, a wide area network such as the Internet, telephone networks including telephone networks with dedicated communication links, connection-less network, and wireless networks. In the illustrative example shown in FIG. 1, the network 110 is the Internet. Each of the computers 102, 104, 106 and 108 shown in FIG. 1 is connected to the network 110 via a suitable communication link, such as a dedicated communication line or a wireless communication link.

In an illustrative example, computer 102 serves as a Image Analysis Unit (“IAU”) that includes an information gathering unit 112, a statistical analysis unit 114, and a profile generation unit 116. The number of computers and the network configuration shown in FIG. 1 are merely an illustrative example. One having skill in the art will appreciate that the IAU 100 may include a different number of computers and networks. For example, computer 102 may include the information gathering unit 112 as well as one or more of the statistical analysis unit 114. Further, the profile generation unit 116 may reside on a different computer than computer 102. In another embodiment, the IAU may reside within the device capturing the image such that the capture and analysis of the image is performed on a single device.

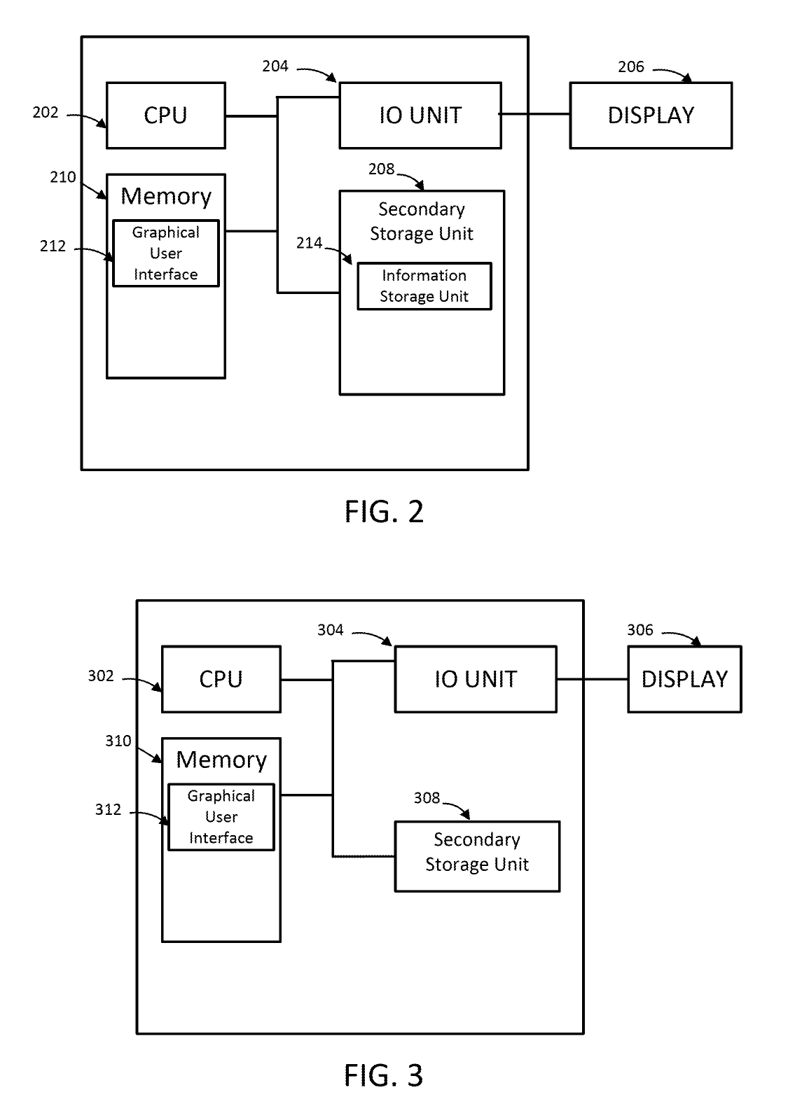

FIG. 2 shows a more detailed depiction of the computer 102. The computer 102 comprises a central processing unit (CPU) 202, an input output (IO) unit 204, a display device 206 communicatively coupled to the IO Unit 204, a secondary storage device 208, and a memory 210. The computer 202 may further comprise standard input devices such as a keyboard, a mouse, a digitizer, or a speech processing means (each not illustrated).

The computer 102's memory 210 includes a Graphical User Interface (“GUI”) 212 that is used to gather information from a user via the display device 206 and I/O unit 204 as described herein. The GUI 212 includes any user interface capable of being displayed on a display device 206 including, but not limited to, a web page, a display panel in an executable program, or any other interface capable of being displayed on a computer screen. The GUI 212 may also be stored in the secondary storage unit 208. In one embodiment consistent with the present invention, the GUI 212 is displayed using commercially available hypertext markup language (“HTML”) viewing software such as, but not limited to, Microsoft Internet Explorer, Google Chrome or any other commercially available HTML viewing software. The secondary storage unit 208 may include an information storage unit 214. The information storage unit may be a rational database such as, but not including Microsoft's SQL, Oracle or any other database.

FIG. 3 shows a more detailed depiction of the computers 104, 106 and 108. Each computer 104, 106 and 108 comprises a central processing unit (CPU) 302, an input output (IO) unit 304, a display device 306 communicatively coupled to the IO Unit 304, a secondary storage device 308, and a memory 310. Each computer 104, 106 and 108 may further comprise standard input devices such as a keyboard, a mouse, a digitizer, or a speech processing means (each not illustrated).

Each computer 104, 106 and 108's memory 310 includes a GUI 312 which is used to gather information from a user via the display device 306 and IO unit 304 as described herein. The GUI 312 includes any user interface capable of being displayed on a display device 306 including, but not limited to, a web page, a display panel in an executable program, or any other interface capable of being displayed on a computer screen. The GUI 312 may also be stored in the secondary storage unit 208. In one embodiment consistent with the present invention, the GUI 312 is displayed using commercially available HTML viewing software such as, but not limited to, Microsoft Internet Explorer, Google Chrome or any other commercially available HTML viewing software.

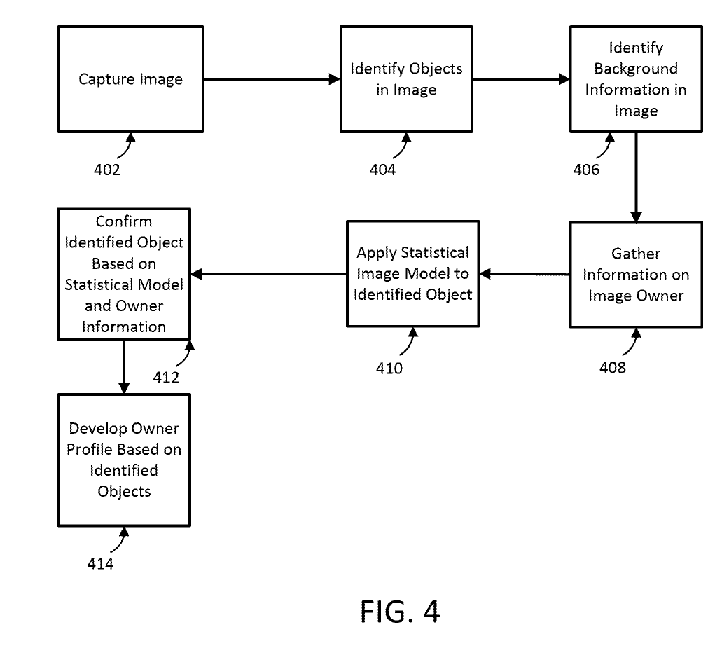

FIG. 4 depicts an illustrative example of the operation of the IAU 100. In step 402, the information gathering unit 112 gathers information related to a user connected to the network 110. The information may be gathered from one or more locations where the user has posted information. As an illustrative example, the information gathering unit 112 may gather information from multiple social media web sites. The information gathered may include, but is not limited to, text related to the user, images of the user, images of topics of interest to the user, the textual information related to the images or the location where the image was taken such as the GPS coordinates of the image location. In step 404, the image analysis unit 114 identifies potential objects in each image. The image analysis unit 114 may use any known object identification method including, but not limited to, edge matching, gradient matching, divide and conquer search or any other image identification technique. The image analysis unit 114 may use one or more these techniques to identify potential objects.

In step 406, the image analysis unit 114 determines which potential objects are located in the foreground and the background of each image, and categorizes each potential object as being a background or foreground image. The image analysis unit 114 may determine whether an image is a foreground or background image by comparing the size and perspective of each object in relation to another object in the image. The determination of the position of an image in the foreground or the background may be used in a statistical analysis related to the user where background images are used to identify tangential information related to an image or a user, and foreground information is used to identify the user and objects of interest to the user.

In step 408, the information gathering unit 112 gathers information related to each image. The information related to each image may include the names and social media sites of the persons in the image, a comment or tag associated with the image or any other information related to the image. The information may also include, the type of image (i.e. a photo or a screen shot), the size and orientation of the image, the predominant colors in the image, the resolution of the image or any other information pertaining to the image. In one embodiment, the image analysis unit 114 may identify text from the image. As an illustrative example, the image analysis unit 114 may identify text on signs or posters in the background of an image and associate the identified text with the image or with an object in the image.

In step 410, the image analysis unit 114 applies a statistical framework to each object to identify the object. As an illustrative example, the image analysis unit 114 may apply a statistical analysis to the edges of each object by comparing the edges of each object to the edges of a known object. If a statistical correlation exists between the edges of the identified object and the edges of a known object, the edges of the identified object may be adjusted based on the edges of the known object to clarify the identity of the object. In one embodiment, the image analysis unit 114 may utilize the information associated with the image or object to identify the object. The image analysis unit 114 may also compare known objects to the identified objects to determine a statistical probability that the identified object is the known object.

In step 412, the image analysis unit 114 identifies each object based on the statistical model. After an image is identified, the image is stored in a library where the image can be used to identify future objects. Each identified image is categorized based on the identification. The image analysis unit 114 may also identify characteristics within the image such as facial features, expressions, activities being performed by persons in the image or any other characteristics. The image analysis unit 114 may identify the additional characteristics by comparing different features of an object with other known features of an object. The image analysis unit 114 may also analyze the information related to the object such as comments or captured text to determine the characteristic of the object.

In step 414, an owner profile is developed utilizing the captured objects and information from the user. As an illustrative example, a user may have postings of the user with children and no spouse. The information extraction unit 116 may determine that the user is a single parent and incorporate that characteristic into the user's profile. In another embodiment, images of the user may be posted on other user's social media pages to provide additional information on the user based on the profile of the other user's social media. In another embodiment, the color tones of the user's makeup in an image may indicate that the user follows a particular type of music. In another embodiment, objects identified as commercial products may be used to determine a user's interest in purchasing an product or a similar product. In another embodiment, the user's physical characteristics may be analyzed over time to determine physical changes to the user such as plastic surgery, weight gain or weight loss or aging.

In one embodiment, a group of images are analyzed to determine the space or area where an object or person is located. Each object may be associated a category identifying the space or a related or potential space. The space may be identified by determining overlapping categories of objects identified in the image. As an illustrative, but non limiting, example, a chair, desk, phone and calendar may be identified in an image. Each of these objects may be associated with an office space. The image analysis unit 114 may categorize the space in the image as an office. By categorizing the space as an office, all objects not associated with an office category would not be used to determine additional objects in the image. Further, for a video stream, images in successive video frames would be identified using objects associated with an office thereby increasing the speed and accuracy of the identification.

In one embodiment, the image analysis unit 114 identifies objects in successive frames of a video stream. The image analysis unit 114 may identify object type and relative position to other objects to determine whether the object is in motion or to identify and categorize the movement of the object. As an illustrative example, the image analysis unit 114 may identify a person in the frame of a video stream and review the relative position of the object in successive frames to determine if the object is moving. The image analysis unit 114 may compare the object and movement, along with other information on the image and the object to determine if the movement can be categorized into a known movement such as dancing or running.

In another embodiment, the image analysis unit 114 generates a user profile based on identified objects and activities in images and videos on a user's social media pages. The image analysis unit 114 may also generate a listing of physical attributes related to the user such as height, weight, facial features, body type or any other physical attribute and generates a dating profile for the user. In another embodiment, the image analysis unit 114 determines potential romantic matches for a user based on the identified interests of other users. In another embodiment, the image analysis unit 114 may generate a value indicating the level of physical attractiveness of a user based on physical information gathered from the user's images.

In the present disclosure, the words “a” or “an” are to be taken to include both the singular and the plural. Conversely, any reference to plural items shall, where appropriate, include the singular.

It should be understood that various changes and modifications to the presently preferred embodiments disclosed herein will be apparent to those skilled in the art. Such changes and modifications can be made without departing from the spirit and scope of the present disclosure and without diminishing its intended advantages. It is therefore intended that such changes and modifications be covered by the appended claims.

What is claimed:

1. A method of generating a user profile including the steps of:
gathering images associated with the user;
identifying potential objects in the images;
gathering information on the user and the images and objects in the images;
applying a statistical model to identify the objects based on the images and information;
generating a profile of the user based on the identified objects and information.

2. The method of claim 1 wherein the images are gathered from more than one location.

3. The method of claim 1 including the step of identifying if the potential object is in the foreground or background of the image.

4. The method of claim 1 including the step of identifying text in the image.

5. The method of claim 1 including the step of identifying a type of space the potential object is located.

6. The method of claim 1 including the step of identifying at least one person in the image.

7. The method of claim 1 including the step of associating each identified object with a predetermined category.

8. The method of claim 6 including the step of gathering information on the at least one person identified in the image.

9. The method of claim 1 wherein potential objects are identified using a statistical analysis.

10. The method of claim 1 including the step of identifying a relative position of each potential object.
